(19) United States
(12) Patent Application Publication
(10) Pub. No.: US 2008/0201314 A1
(43) Pub. Date: Aug. 21, 2008

(54) METHOD AND APPARATUS FOR USING MULTIPLE CHANNELS OF DISSEMINATED DATA CONTENT IN RESPONDING TO INFORMATION REQUESTS

(76) Inventors: John Richard Smith, New Hyde Park, NY (US); Ioana Roxana Stanoi, San Jose, CA (US); Jelena Tesic, New York, NY (US)

Correspondence Address: DUKE W. YEE, YEE & ASSOCIATES, P.C., P.O. BOX 802333, DALLAS, TX, 75380, US

(21) Appl. No.: 11/676,852

(22) Filed: Feb. 20, 2007

(51) Int. Cl. G06F 17/30

(52) U.S. Cl. 707/5; 707/E17.028

(57) ABSTRACT

Embodiments of the invention exploit the complementary and correlated information that is available across multiple channels of digital multimedia distribution, in order to ensure more efficient multimedia data access. One embodiment of the invention, directed to a method for generating a response to a specified request for information, is associated with multiple channels that are each adapted to carry and disseminate data content. The method comprises extracting data elements from each of the multiple channels, wherein each extracted data element pertains to one dimension of a plurality of correlation related dimensions. The method further comprises assigning each extracted data element to one of a plurality of correlation sets, wherein all the extracted data elements assigned to a particular set pertain to the same dimension, and each set is assigned data elements extracted from two or more different channels. Two or more of the correlation sets associated with the request are then selected, and the data content thereof is used to generate the response to the specified request.

This invention was made with Government support under Contract No. 2004*H839800*000 awarded by Advanced Research Development Agency. The Government has certain rights in this invention.

### BACKGROUND OF THE INVENTION

1. Field of the Invention

The invention disclosed and claimed herein generally pertains to a method for using data content disseminated by multiple channels, in order to improve the response to a specified request for information. More particularly, the invention pertains to a method of the above type wherein the multiple channels distribute data content supplied by different multimedia sources, such as Internet websites, television broadcasts, IPTV and wireless device communications. Even more particularly, the invention pertains to a method of the above type that is adapted to exploit complementary and correlated information provided by the multiple channels of distribution, in order to provide deeper insight into the underlying semantics of the data content, and also to provide more coherent information threads.

2. Description of the Related Art

Expansive video information dissemination, via multiple distribution sources, poses an increasingly greater challenge for intelligence analysts. This dissemination of information now includes global sources, such as foreign news broadcasts, and further includes distributed multi-source multimedia (image, video and audio), Internet websites, and wireless personal communications. Such enormous expansion in information dissemination provides a new and overwhelming challenge for efficient content understanding and indexing. Existing content analysis and search multimedia services are typically based on processing and analysis of textual features such as multimedia file names, textual captions, speech transcripts and associated tags. Organizations that perform these activities include, for example, Google and its associate YourTube, and Yahoo Video and its associates Flickr, Blinkx TV, and MySpace. This, of course, assumes the existence of tags. Various speech recognition and machine translation techniques are used to enhance the existing textual features. However, such dependence on text makes the content, understanding, and search of multimedia data unreliable, when dealing with content from sources without adequate textual information, or with foreign sources.

At present, solutions to multimedia indexing mainly analyze a single source or instance of the provided data content, or deal with only a single channel of distribution that provides one snapshot into the semantics of the content. Traditional text-based indexing of multimedia content is generally not appropriate for multimedia content, where content description can have different meanings, or where text indexing does not describe digital content sufficiently well. Text-based indexing is also unreliable, when dealing with content from foreign sources or sources without adequate textual information. Topic threading summarization and linking research that relies on textual features, from news wires, speech recognition or machine translation transcripts of news video, is discussed in the DARPA Translingual Information Detection Extraction and Summarization (TIDES) program for “Topic Detection and Tracking” (TDT). Existing web summarization and linking services, e.g. Google news and Blinkx TV, are of narrow scope and typically based on text, file names or closed captions. Sun, J., Wang, X., Shen, D., Zhen, H., and Chen, Z., “Mining clickthrough data for collaborative web search,” International Conference on World Wide Web (WWW), May 2006, discusses web search performance by exploring group behavior patterns of search activities based on the click through data. However, while there has been research behind efforts such as mining web-blog patterns and mining web tags to extract relevant annotations, very useful or rich information contained in the visual and temporal dimensions of multimedia content has been largely ignored.

On the content exploration side, current mining methods rely on deriving associations only within one domain, and thus likewise have a very narrow scope. Associations in video domains are discussed by X. Zhu, X. Wu, A. K. Elmagarmid, and Z. Feng, L. Wu in “Video Data Mining: Semantic Indexing and Event Detection from the Association Perspective,” IEEE Transactions on Knowledge and Data Engineering, vol. 17, no. 5, pp. 665-677, May 2005, and by Kender and Naphade, in “Visual concepts for news story tracking: Analyzing and exploiting the NIST TRECVID video annotation experiment,” IEEE Computer Vision and Pattern Recognition, pp. 1174-1181, 2005. Tesic and Smith, in “Semantic Labeling of Multimedia Content Clusters,” IEEE Intl. Conf. on Multimedia and Expo (ICME), 2006, extend the scope of video summarization to allow users to more efficiently navigate the semantic and metadata space for the video data set. These references further show that current methods rely on mining information and deriving associations within only one multimedia domain, and are thus of very narrow scope. Little effort has previously been devoted to predicting important patterns in a new domain, or using patterns to extract threads or to label similar content across domains. This further emphasizes the conclusion that rich multimedia information over multiple sources has been largely ignored.

In view of the drawbacks described above, there is a growing need to both enrich semantic metadata for multimedia objects provided by multiple sources, and to support content analysis, understanding and search across multiple domains. In the absence of a means or method that addresses this problem, search is limited to a specific domain such as: (i) Keyword search for text; (ii) Context search over text based on keywords and ontologies/dictionaries; (iii) Video retrieval based on speech recognition, closed captioning, manual annotations and visual semantics within narrow scope; and (iv) Picture search based on tagging, file name, and camera metadata.

### SUMMARY OF THE INVENTION

The invention provides an efficient and scalable solution for multimedia linking, in order to ensure more efficient multimedia data access. Embodiments of the invention exploit the complementary and correlated information that is available across multiple channels of digital multimedia distribution, in order to provide both deeper insights into the underlying semantics of the content and more coherent information threads over information channels. Embodiments of the invention can facilitate integrated search over text, video and pictures, by correlating the multiple channels of available information (horizontal-based search), and can also allow content resolution for thread extraction and for deeper understanding of a given context (vertical search space).

One embodiment of the invention, directed to a method for generating a response to a specified request for information, is associated with multiple channels that are each adapted to carry and disseminate data content. The method comprises extracting data elements from each of the channels, wherein each extracted data element pertains to at least one dimension of a plurality of correlation related dimensions. The method further comprises assigning each extracted data element to one of a plurality of correlation sets, wherein all the extracted data elements assigned to a particular set pertain to the same correlation related dimension, and at least one of the sets is assigned data elements extracted from two or more different channels. Two or more of the correlation sets associated with the request are then selected, and the data content thereof is used to generate the response to the specified request.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a schematic drawing illustrating the construction of syntactic containers for an embodiment of the invention, wherein the syntactic containers hold information provided by multimedia content from multiple channels.

FIG. 2 is a schematic diagram showing an embodiment of the invention using the syntactic containers of FIG. 1.

FIG. 3 is a schematic diagram depicting use of the embodiment of FIG. 2.

FIG. 4 is a flow chart showing principal steps for an embodiment of the invention.

FIG. 5 is a block diagram showing a data processing system that may be used to implement embodiments of the invention.

### DETAILED DESCRIPTION OF THE PREFERRED EMBODIMENT

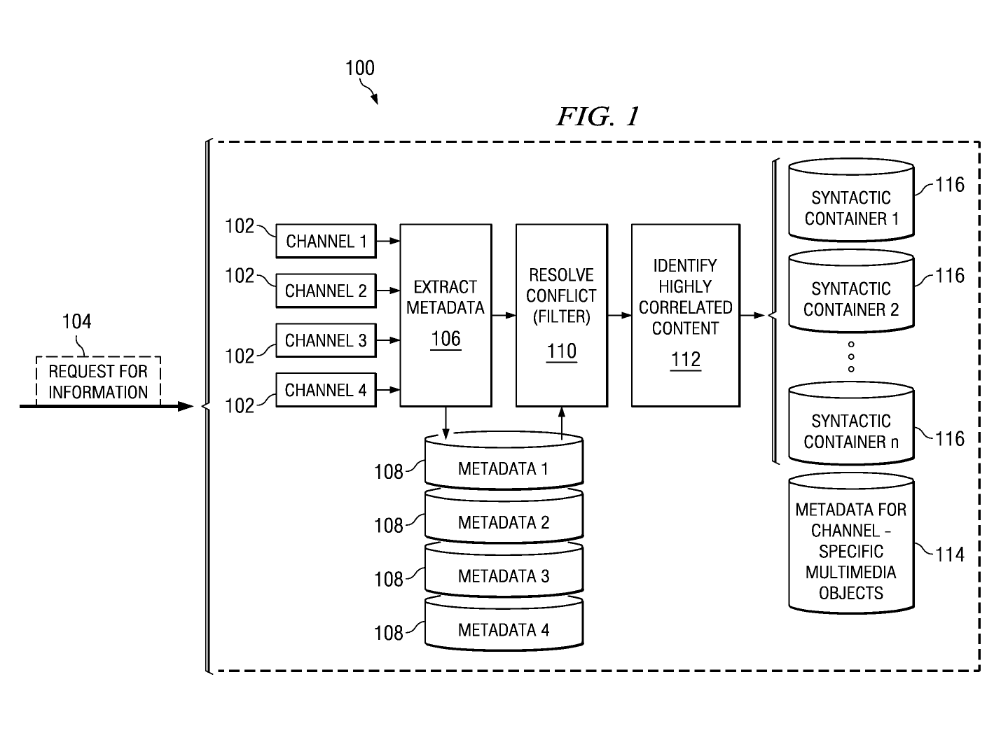

Referring to FIG. 1, there is shown the general architecture of a system 100 that can support correlation of information carried and disseminated by multiple information channels 102. Four channels 102 are shown in FIG. 1 by way of example, depicted as channels 1-4, but embodiments of the invention can generally have two or more channels 102, up to a reasonable number. Channels 102 pertain to one or more domains, such as the domains of business, healthcare, entertainment, sports, science, arts, weather and travel, by way of example and not limitation.

Each channel 102 originates with one of the sources in a set of distributed multimedia information sources (not shown). By way of example and not limitation, such sources could include Internet websites, amateur radio archives, broadcast news, libraries, newspapers, business and government archives, movies, television shows and information contained in scientific and medical databases. Thus, the information provided by multiple channels 102 comprises unstructured multimodal information, and can be in a variety of forms including, without limitation, text, audio, video, graphics and/or images. As an illustration, a particular image or video clip can be used in both an Internet website and a television broadcast. Information provided by the website in regard to the image or video clip can include web page text and metadata, such as alt tag, image name and URL. Television broadcasts may furnish information such as speech transcripts, and also the identities of television programs that displayed the image or video clip. It is anticipated that activities pertaining to the image or video clip, such as searching, analysis and indexing, can be significantly improved by using all of this information cumulatively.

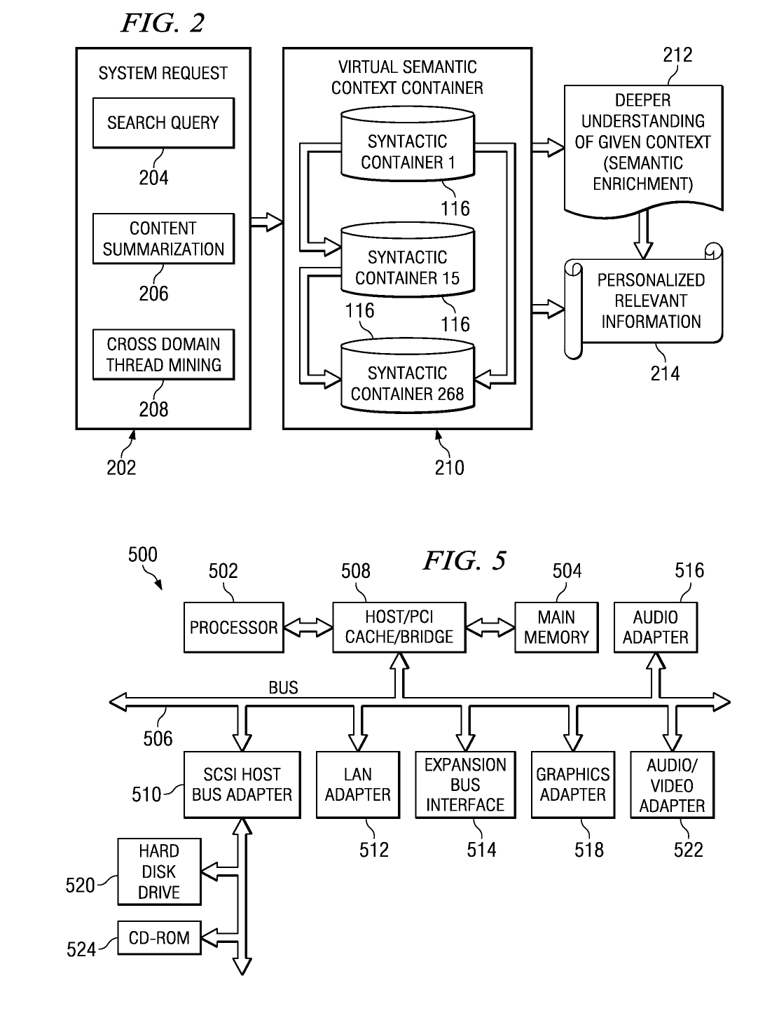

FIG. 1 further shows a request for information 104 that has been received by system 100. Information request 104 can be as general as providing a global indexing to the content arriving from channels 102, and as specific as a search request. In order to provide a response to a request, an embodiment of the invention implements a procedure that generally correlates multiple channels of distributed multimedia content, exploits the context of use of the multimedia content, as defined by the request, and then derives semantic understanding of the multimedia content. Some of the types of information requests that can be made to the system are discussed hereinafter, in further detail, in connection with FIG. 2. Such requests usefully include, without limitation, search queries, content summarization and cross domain thread mining.

As a first step in the procedure of responding to a request, system 100 may crawl or visit respective channels 102, and follow hyperlinks thereof, to select particular channels and related multimedia objects that are pertinent to information request 104. Referring further to FIG. 1, there is shown a function block 106 directed to extracting metadata and semantic information from the selected channels. More particularly, metadata and semantics are extracted from the multimedia objects provided by the crawl operation, wherein the multimedia objects can be elements of data content such as image, graphic, audio, and video information, as well as textual information. Types of metadata extracted from the multimedia objects include, without limitation, content descriptors, surrounding text, relevant links and available contextual information such as dates and times. Herein, the terms “semantics”, “semantic data” and “semantic information” are used to mean any wording or text that describes characteristics or features of a multimedia object. For example, characteristics of an image, such as whether the image depicts an outdoor scene, the sky or a human face, can be automatically extracted from the image and identified by a textual word or phrase. Such textual information comprises semantics of the image. Semantic extraction can be used to detect the presence or absence of semantic elements in data content that includes, for example, sites, scenes, objects, events, persons, activities and entities.

FIG. 1 shows respective elements of extracted metadata and semantics placed in corresponding metadata containers 108. Function block 110 provides a filtering step, to resolve any conflicts between different extracted semantics or metadata elements. For example, the extracted metadata may show two different dates for the creation of a particular multimedia object. This conflict is resolved at function block 110, by automatically selecting one of the dates as being correct.

At function block 112, an element or artifact of data content in one of the channels 102 is compared with data elements in one or more of the other channels, in order to identify multimedia objects or data content in different channels 102 that is highly correlated. Usefully, correlation is implemented by content-based similarity identification or clustering of objects in different channels, or by near-duplicate detection of multimedia objects and text streams. In similarity detection, an effort is made to locate exact copies or very similar content of particular data content or multimedia objects in different channels, wherein the multiple channels collectively contain unstructured multimodal information content. Similarity detection can be used for data content or objects such as images, video, audio, text, and graphics content.

In embodiments of the invention, the correlation effort compares data elements such as semantic data and metadata extracted as described above, in order to identify similar content or multimedia objects in the different channels 102. In some of these embodiments, as described above, the correlation effort directly corresponds to and is defined by information request 104. In other embodiments, however, as described hereinafter, the correlation effort uses extracted semantics and metadata that was not generated in response to the information request.

It will be readily apparent that in order to correlate data content that has been disseminated or distributed by different channels, as described above, there must be a common basis, characteristic or feature that defines correlation. Herein, the term “dimension” is used to mean a particular basis for data content correlation. For example, a particular image may be widely used across multiple channels 102 in different contexts and with different texts. At the same time, a particular paragraph of text may be used with the particular image, but may also be used with a number of other images across the channels. For this situation, one dimension of correlation would be each data element provided by the multiple channels that contains the image, regardless of context or accompanying text. Another dimension would be each data element that contained the particular paragraph, likewise regardless of context or associated images.

After identifying correlated content that has been obtained from different multimedia channels, based on respective dimensions of correlation, collateral information relevant to the distribution of the correlated content is analyzed, wherein examples of such collateral information could include speech transcripts, closed captions, website text and related multimedia content, such as previous and subsequent videos in the same news source, and direct links from the same URL. Following analysis, the correlated information is grouped or placed into correlation sets, or syntactic containers 116, wherein each set or container is associated with a dimension of correlation. Each syntactic container 116 is a dynamic structure that only holds data content that is highly correlated with its associated dimension.

As stated above, the correlation effort and creation of correlation sets or syntactic containers 116 is closely associated with the extracted semantic data and metadata. The extracted semantics and metadata is used in the correlation procedure to identify similar and near-duplicate data across the multiple channels, and thus to construct syntactic containers 116. As indicated above, in one mode the extracted semantics and dimensions of correlation are defined by a particular request. Accordingly, syntactic containers 116 are constructed in response to, and thus after receiving, the request for information.

In another mode, a large number of syntactic containers 116 are constructed in accordance with the correlation procedure described above, wherein each container is associated with a pre-specified dimension of correlation. FIG. 1 shows the syntactic containers numbered from 1 to n, and in this mode n could be 500 or greater. However, for this mode, respective syntactic containers 116 are created prior to receipt of a particular request for information, and reside in a database or the like, as an extended indexing structure. Then, when a particular request for information is received, system 100 selects from the previously created syntactic containers 116 only those containers that have dimensions of correlation that are relevant to the request. For example, some or all of the syntactic containers 116 could have been previously created in response to prior information requests.

It is anticipated that certain semantics and metadata associated with a multimedia object or content in one of the multiple channels 102 will be specific to that channel, and thus will not correlate with content in any of the other channels. FIG. 1 further shows the container 114 for holding semantics and metadata of this type.

Referring to FIG. 2, there is shown a request for information 202 that may be one of a number of request types, wherein the requests 202 are a subset of request 104 of FIG. 1. For example, the request may simply be a search query 204, to search for specified information or to determine the answer to a question. Alternatively, the request could be for a content summarization 206, to provide a summary of specified data content. The third type of request, cross domain thread mining 208, would seek to determine how a particular topic or other search object threads across different channels representing different domains, or across the same channel at different times.

Referring further to FIG. 2, there is shown a virtual semantic context container 210 constructed in response to request 202. Virtual semantic context container 210 acts to match a user or application request to syntactic container information by means of loosely correlated semantic content, such as similar visual content, and/or similar tagging, key words or annotations. More particularly, in response to a particular request 202, contextual information related to the request is used to select the syntactic containers 116, described above, that are most pertinent to the request. By way of example, FIG. 2 shows that syntactic container numbers 1, 15 and 268 have been selected, as the syntactic containers 116 found to be relevant to the request in an extended indexing structure of the type described above. Contextual information used for the selection, by way of example, could include time, place, source, person, event, object and scene.

Alternatively, each of the syntactic containers 116 could have been constructed on the fly, after receiving a particular request 104, in order to provide highly correlated information along dimensions pertinent to the request.

It is to be emphasized that creation of virtual semantic context container 210 provides two levels of content from multiple channels 102 in FIG. 1, wherein both levels are related to a particular request. Each of the syntactic containers 116 holds data that is highly correlated, along a single dimension that is pertinent to the request. At the same time, the loosely correlated semantic container 210 holds information that has been personalized, to match the context of the particular request. Thus, the method described above in connection with FIGS. 1 and 2 very effectively acquires data content from multiple channels, wherein all the acquired data is directed to the particular request.

As a further benefit, the configuration provided by semantic context container 210 can be used to carry out different types of searches, usefully referred to as horizontal and vertical searches. As indicated by result 212 shown in FIG. 2, a horizontal search provides a deeper understanding of the context of specified information, by furnishing semantic enriched content related thereto. A horizontal search is also referred to as a union, since data content from a plurality of different syntactic containers is unified, or brought together.

A vertical search is integrated over multiple channel domains, to locate information that is relevant and thus personalized to the request. FIG. 2 shows a vertical search result 214. A vertical search is also referred to as an intersection, since data content from different syntactic containers is being intersected.

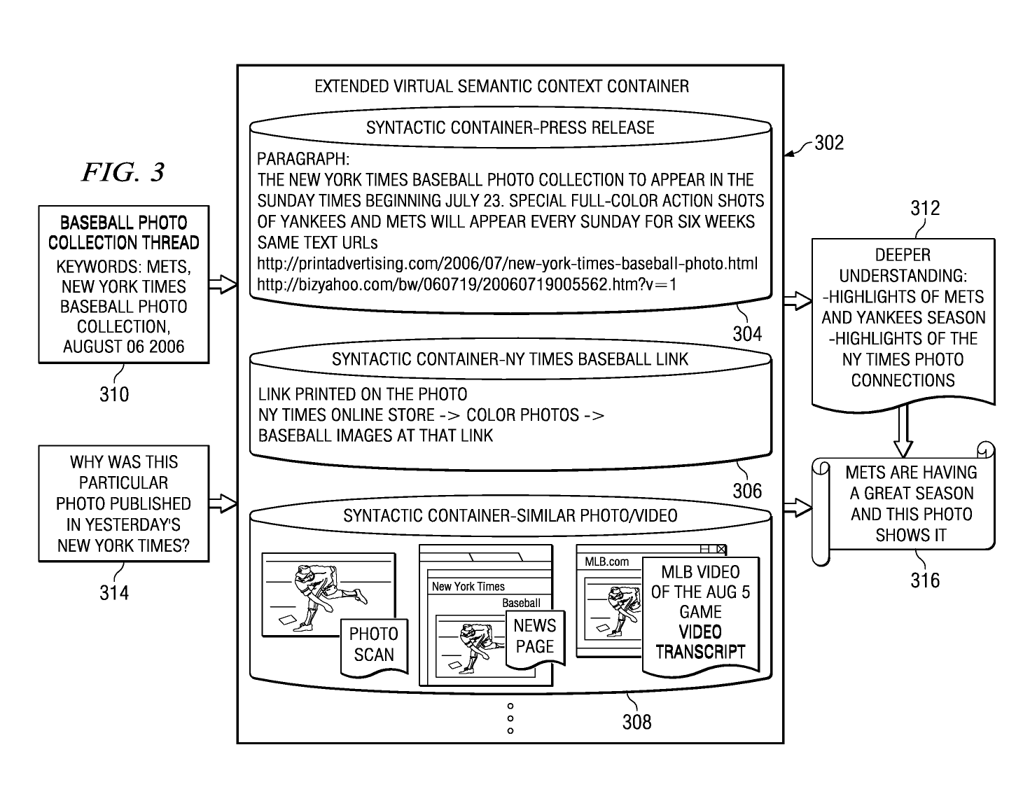

Referring to FIG. 3, there is shown a virtual semantic context container 302, of a type similar to semantic context container 210 in FIG. 2 described above. Semantic context container 302 is provided with specific syntactic containers 304-308, for use in further illustrating horizontal and vertical types of searches. Content and metadata of syntactic container 304 is correlated to newspaper content pertaining to a press release on the topic of baseball in New York. Syntactic containers 306 and 308 provide content and metadata generated by Internet websites and television news, respectively. FIG. 3 further shows a search request 310 that is formulated as a thread mining extraction. In response to request 310, a horizontal search is made of the data content in semantic context container 302, in order to generate the result 312. This result provides a deeper understanding of information elements included in request 310.

FIG. 3 further shows a request 314 directed to semantic context container 302, wherein request 314 simply seeks an answer to a question. In response, a vertical search is carried out within semantic context container 302, to provide an appropriate answer as the result 316.

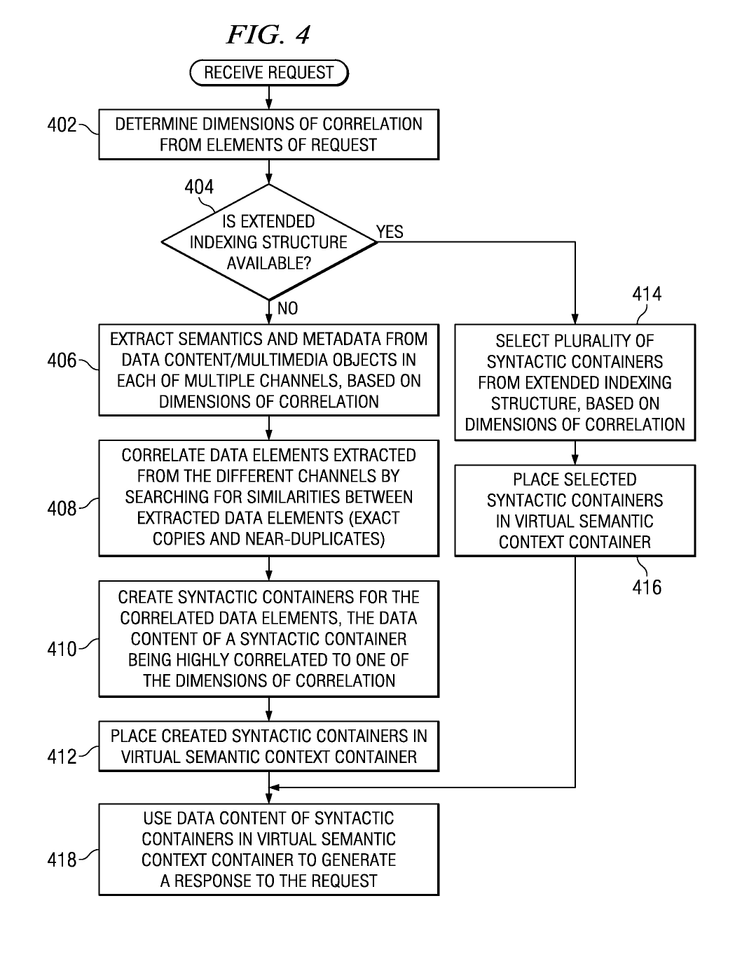

Referring to FIG. 4, there is shown a flow chart summarizing principal steps of the method described above. After receiving a request for information, dimensions of correlation are determined at step 402, from elements of the request. For example, semantic extraction may be used to select different semantic elements from the request, which can then be used as correlation elements. If the request is as general as ‘jointly index’ incoming data, then most of the foreseen semantic elements relevant to joint indexing are used. The extracted semantic elements can include, for example, sites, scenes, objects, events, and specified activities, persons or entities.

At step 404, it is necessary to determine whether an extended indexing structure, of the type described above, is available for use. To be usable, an indexing structure would have to have syntactic containers corresponding to all of the dimensions of correlation that are defined by the information request. If this is not the case, the method proceeds to step 406, to extract semantic data and metadata from data content in each of the multiple channels, such as channels 102 in FIG. 1. Semantic extraction is usefully based on the correlation dimensions defined by the information request, and detects the presence or absence of semantic elements, such as sites, scenes, objects and events as referred to above.

Following extraction of respective data elements, extracted elements from different channels are correlated with one another, at step 408. For example, successive extracted data elements could be compared with a dimension of correlation, and would be accepted if they were found to be identical or similar to the dimension, to within a pre-specified degree. All such data elements from different channels would be highly correlated with one another, and would then all be placed in a syntactic container corresponding to the dimension. Step 410 shows creation of syntactic containers for the respective dimensions of correlation. Step 412 shows placement of the created syntactic containers, together with the data content thereof, into a virtual semantic context container as described above in connection with FIG. 2.

Referring further to FIG. 4, if it is determined at step 404 that an extended indexing structure is available, a plurality of syntactic containers are selected from the structure at step 414. Selection could be made by matching dimensions of respective syntactic containers with the correlation dimensions defined by the information request. Alternatively, selection could be made by comparing semantic elements of respective syntactic containers with semantic elements or metadata of the information request, to determine a loose correlation based on the number of semantic elements found to be similar. The comparison process could also use an algorithm to carry out the semantic scoring of related metadata. As show by step 416, selected syntactic containers are placed in the virtual semantic context container.

At step 418, all the data content of the syntactic containers located in the virtual semantic context container is used collectively to respond to the information request. Software tools such as clustering, association rules, and various statistical and prediction packages are examples of tools that could be used to process the data in the virtual semantic context container, in order to provide a response to the information request.

Referring to FIG. 5, there is shown a block diagram of a generalized data processing system 500 which may be adapted to implement embodiments of the invention described herein. It is to be emphasized, however, that the invention is by no means limited to such systems. For example, embodiments of the invention can also be implemented with a large distributed computer network and a service over the Internet, as may be applicable to distributed systems, LANs and WWWs.

Data processing system 500 exemplifies a computer, in which code or instructions for implementing embodiments of the invention may be located. Data processing system 500 usefully employs a peripheral component interconnect (PCI) local bus architecture, although other bus architectures such as Accelerated Graphics Port (AGP) and Industry Standard Architecture (ISA) may alternatively be used. FIG. 5 shows processor 502 and main memory 504 connected to PCI local bus 506 through Host/PCI Cache bridge 508. PCI bridge 508 also may include an integrated memory controller and cache memory for processor 502. It is thus seen that data processing system 500 is provided with components that may readily be adapted to provide other components for implementing embodiments of the invention as described herein. Referring further to FIG. 5, there is shown local area network (LAN) adapter 512, small computer system interface (SCSI) host bus adapter 510, and expansion bus interface 514 respectively connected to PCI local bus 506 by direct component connection. Audio adapter 516, graphics adapter 518, and audio/video adapter 522 are connected to PCI local bus 506 by means of add-in boards inserted into expansion slots. SCSI host bus adapter 510 provides a connection for hard disk drive 520, and also for CD-ROM drive 524.

The invention can take the form of an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device. The invention can further take the form of television devices, wireless communication devices, and other devices that can correlate or otherwise process multimedia data of any type.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. In association with multiple channels that are each adapted to carry and disseminate data content, a method for generating a response to a specified request comprising the steps of:
extracting data elements from each of said multiple channels, wherein each extracted data element pertains to at least one dimension of a plurality of dimensions of correlation;
assigning each extracted data element to one of a plurality of correlation sets, wherein all of the extracted data elements assigned to a particular set pertain to the same dimension of correlation, and at least one of the sets is assigned data elements extracted from two or more different channels;
selecting two or more of said correlation sets that are associated with said request; and
using the data content of said selected correlation sets to generate said response to said specified request.

2. The method of claim 1, wherein:
said selecting step comprises selecting two or more of said correlation sets for inclusion in a semantic context container, wherein the collective information contained in said semantic context container is used to generate said response to said specified request.

3. The method of claim 2, wherein:
each of said correlation sets comprises a syntactic container adapted to hold data elements that are highly correlated with one of said dimensions of correlation.

4. The method of claim 3, wherein:
said extracted data elements include metadata and semantic data elements.

5. The method of claim 3, wherein:
said extracted data elements are used in providing said highly correlated data elements for each of said syntactic containers.

6. The method of claim 3, wherein:
said selecting step comprises selecting a plurality of said syntactic containers from a total number of stored syntactic containers constructed prior to a receipt of said specified request, wherein said total number substantially exceeds the number of syntactic containers of said plurality.

7. The method of claim 3, wherein:
each of said syntactic containers is constructed following a receipt of said specified request.

8. The method of claim 3, wherein:
said selecting step comprises either intersecting data from a plurality of said syntactic containers, or unifying data from a plurality of said syntactic containers, selectively, in order to provide correlated collective information for use in generating said response.

9. The method of claim 1, wherein:
said extracting step comprises detecting the presence or absence of semantic data elements in said multiple channels that respectively pertain to said specified request, wherein said semantic data elements are each selected from a group that includes elements pertaining to at least sites, scenes, objects, events, activities, persons and specified entities.

10. The method of claim 3, wherein:
contextual data elements related to said specified request are used to select two or more of said syntactic containers for inclusion in said semantic context container.

11. The method of claim 10, wherein:
said contextual data elements are selected from data content that includes at least visual content, tagging, key words, and associated annotation including visual descriptors, semantic descriptors, embedded metadata, and extracted metadata from the title, date, captions, surrounded HTML, channel information or time.

12. The method of claim 1, wherein:
said multiple channels are selected from several domains that include at least business, healthcare, entertainment, interactive and one-way, games, sports, science, arts, weather and travel.

13. In association with a computer system and multiple channels that are each adapted to carry and disseminate data content, a computer program product in a computer readable medium for generating a response to a specified request, said computer program product comprising:
first instructions for extracting data elements from each of said channels, wherein each extracted data element pertains to at least one dimension of a plurality of dimensions of correlation;
second instructions for assigning each extracted data element to one of a plurality of correlation sets, wherein all of the extracted data elements assigned to a particular set pertain to the same dimension of correlation, and at least one of the sets is assigned data elements extracted from two or more different channels;
third instructions for selecting two or more of said correlation sets that are associated with said request; and
fourth instructions for using the data content of said selected correlation sets to generate said response to said specified request.

14. The computer program product of claim 13, wherein:
said two or more of said correlation sets are selected for inclusion in a semantic context container, wherein the collective information contained in said semantic context container is used to generate said response to said specified request.

15. The computer program product of claim 14, wherein:
each of said correlation sets comprises a syntactic container adapted to hold data elements that are highly correlated with one of said dimensions of correlation.

16. The computer program product of claim 15, wherein:
said extracted data elements are used in providing said highly correlated data elements for each of said syntactic containers.

17. In a computer system associated with multiple channels that are each adapted to carry and disseminate data content, an apparatus for generating a response to a specified request comprising:
a first component for extracting data elements from each of said channels, wherein each extracted data element pertains to at least one dimension of a plurality of dimensions of correlation;
a second component for assigning each extracted data element to one of a plurality of correlation sets, wherein all of the extracted data elements assigned to a particular set pertain to the same dimension of correlation, and at least one of the sets is assigned data elements extracted from two or more different channels;
a third component for selecting two or more of said correlation sets that are associated with said request; and
a fourth component for using the data content of said selected correlation sets to generate said response to said specified request.

18. The apparatus of claim 17, wherein:
said two or more of said correlation sets are selected for inclusion in a semantic context container, wherein the collective information contained in said semantic context container is used to generate said response to said specified request.

19. The apparatus of claim 18, wherein:
each of said correlation sets comprises a syntactic container adapted to hold data elements that are highly correlated with one of said dimensions of correlation.

20. The apparatus of claim 19, wherein:
said extracted data elements are used in providing said highly correlated data elements for each of said syntactic containers.
